(19) United States
(12) Patent Application Publication
(10) Pub. No.: US 2011/0216125 A1
(43) Pub. Date: Sep. 8, 2011

(54) YELLOW PIGMENT DISPERSION

(75) Inventors: Christian Jackson, Wilmington, DE (US); Robert Paul Held, Newark, DE (US); C. Chad Roberts, Hockessin, DE (US); Nathaniel Reed Schwartz, Newark, DE (US); Gregory R. Schulz, Mt. Pleasant, SC (US)

(73) Assignee: E. I. DU PONT DE NEMOURS AND COMPANY

(21) Appl. No.: 13/128,964

(22) PCT Filed: Dec. 10, 2009
(86) PCT No.: PCT/US09/67528

§ 371 Date: May 12, 2011

Related U.S. Application Data
(60) Provisional application No. 61/121,235, filed on Dec. 10, 2008.

(51) Int. Cl. B41J 2/015; C09D 11/10

(52) U.S. Cl. 347/20; 524/190

(57) ABSTRACT

This invention pertains to an aqueous based dispersion of Pigment Yellow 74 which uses a certain class of polymeric dispersants which dispersant is particularly effective at dispersing the pigment and preventing pigment particle growth on storage. The classes of polymeric dispersants are based on random copolymers of an ionic momomer and a hydrophobic monomer chosen from benzyl(meth)acrylate or alkyl(meth)acrylate where the alkyl group has four to ten carbon atoms and (meth)acrylic acid. The invention also pertains to an inkjet ink comprising this Pigment Yellow 74 dispersion.

This application claims the benefit of U.S. Application Ser. No. 61/121235 filed Dec. 10, 2008.

### BACKGROUND OF THE INVENTION

The present invention pertains to a yellow pigment dispersion and more particularly to a Pigment Yellow 74 dispersion stabilized in aqueous vehicle by a certain class of dispersants. The dispersion is particularly useful as a colorant in an aqueous inkjet ink.

Inkjet printing is a non-impact printing process in which droplets of ink are deposited on a substrate, such as paper, to form the desired image. The droplets are ejected from a printhead in response to electrical signals generated by a microprocessor. Inkjet printers offer low cost, high quality printing and have become a popular alternative to other types of printers.

Ink jet recording is a printing method wherein droplets of an ink composition are ejected and deposited onto a recording medium, such as paper, to conduct printing. This method has a feature that an image having high resolution and quality can be printed at a high speed by means of a relatively inexpensive apparatus. In general, the ink composition used in the ink jet recording comprises water as a main component and, added thereto, a colorant and a wetting agent, such as glycerin, for preventing clogging and other purposes. Water-soluble dyes, by virtue of high chroma of the colorant, abundance in types of usable colorants, solubility in water and other advantageous properties, have been extensively used as the colorant in the ink composition for ink jet recording. The dyes, however, are essentially soluble in water, and hence are often poor in waterfastness and other various properties.

Pigments, as compared to dyes, have superior waterfastness. This has recently led to studies on utilization of pigments as a colorant in the ink composition for ink jet recording from the viewpoint of improving the waterfastness of the printed image. However, among various pigments, only limited pigments can exhibit color reproduction and other properties comparable to dyes. For yellow pigments, use of C.I. Pigment Yellow 74 can be expected to lead to high color reproduction.

C.I. Pigment Yellow 74, when incorporated into an ink jet ink, often exhibits a variety of poor properties that has precluded its general use in ink jet inks. The problems with C.I. Pigment Yellow 74 include being unstable as a dispersed pigment with commonly available dispersants.

U.S. Pat. No. 6,043,297 describes the use of a certain dispersant with C.I. Pigment Yellow 74 to obtain a printed product with good lightfastness, where the certain dispersant is a styrene acrylic resin. The patent does not describe whether this dispersion is stable.

U.S. Pat. No. 6,132,501 describes using a co-milled mixture of C.I. Pigment Yellow 74 and another pigment and using a large amount of humectant in the ink jet ink to obtain a stable pigment. This strategy was meant to solve the problem of using this pigment in an ink jet ink in that it ripens readily in typical aqueous based pigmented ink formulations. This limits its utility because as the particle size grows to unacceptable levels, problems arise related to jetablity (the ability to eject ink from the print head) color gamut, hue shift and density loss.

U.S. Pat. No. 6,136,087 describes the use of crystal growth inhibitors to improve pigments that can have particle size growth.

Even with the aforementioned strategies to obtain stable dispersions, and in turn ink jet inks, there is still a need for effective dispersions of C.I. Pigment Yellow 74 that are stable and produce the high chromo and other inherent attributes of the C.I. Pigment Yellow 74.

### SUMMARY OF THE INVENTION

The present inventors have found that the stability of a dispersion of C. I. Pigment Yellow 74 (PY74) can be improved by dispersing the C. I. Pigment Yellow 74 with a specific class of polymeric dispersants.

Accordingly, an object of the invention is to provide a yellow pigment dispersion composition comprising an aqueous vehicle and Pigment Yellow 74 stabilized by a dispersant polymer absorbed onto the surface of the PY74, said dispersant polymer is a random polymer comprising at least
a. a first monomer which is ionic;
b. a second monomer which is hydrophobic and wherein the second monomer is selected from the group consisting of benzyl(meth)acrylate, substituted benzyl(meth)acrylate and linear, branched and cyclic alkyl(meth)acrylate where the alkyl has four to ten carbons;
c. the second monomer is at least 65 weight % of the polymeric dispersant;
d. the random polymer has a number average molecular weight (Mn) from about 6000 to about 20,000; and
e. the random polymer has an acid number of from about 80 to 200.

Another embodiment provides an inkjet ink set containing as one of the inks the dispersed C.I. Pigment Yellow 7 described above.

Yet another embodiment provides a method for ink jet printing onto a substrate, comprising the steps of, in any workable order:
(a) providing an ink jet printer that is responsive to digital data signals;
(b) loading the printer with a substrate to be printed;
(c) loading the printer with an inkjet ink with the dispersed C.I. Pigment Yellow 74 or an inkjet ink set containing at least the dispersed C.I. Pigment Yellow 74 as set forth above; and
(d) printing onto the substrate using the inkjet ink inkjet ink set in response to the digital data signals.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### DETAILED DESCRIPTION

Unless otherwise stated or defined, all technical and scientific terms used herein have commonly understood meanings by one of ordinary skill in the art to which this invention pertains.

Unless stated otherwise, all percentages, parts, ratios, etc., are by weight. When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, the term “dispersion” means a two phase system where one phase consists of finely divided particles (often in the colloidal size range) distributed throughout a bulk substance, the particles being the dispersed or internal phase and the bulk substance the continuous or external phase.

As used herein, the term “dispersant” means a surface active agent added to a suspending medium to promote uniform and maximum separation of extremely fine solid particles often of colloidal size. For pigments the dispersants are most often polymeric dispersants and usually the dispersants and pigments are combined using dispersing equipment.

As used herein, the term “OD” means optical density. As used herein, the term “aqueous vehicle” refers to water or a mixture of water and at least one water-soluble organic solvent (co-solvent).

As used herein, the term “ionizable groups” means potentially ionic groups. As used herein, the term “AN” means acid number, mg KOH/gram of solid polymer.

As used herein, the term “neutralizing agents” means to embrace all types of agents that are useful for converting ionizable groups to the more hydrophilic ionic (salt) groups.

As used herein, the term “substantially” means being of considerable degree, almost all.

As used herein, the term “Mn” means number average molecular weight.

As used herein, the term “Mw” means weight average molecular weight.

As used herein, the term “Pd” means the polydispersity which is the weight average molecular weight divided by the number average molecular weight.

As used herein, the term “d50” means the particle size at which 50% of the particles are smaller; “d95” means the particle size at which 95% of the particles are smaller.

As used herein, the term “cP” means centipoise, a viscosity unit.

As used herein, the term “TEB” means triethylene glycol monobutyl ether, a reagent supplied by Dow Chemical.

As used herein, the term “Sulfolane” means tetramethylene sulfone.

As used herein, the term “BzMA” means benzyl methacrylate.

As used herein, the term “BMA” means butyl methacrylate.

As used herein, the term “MAA” means methacrylate.

The pigment names and abbreviations used herein are the “al.” designation for pigments established by Society of Dyers and Colourists, Bradford, Yorkshire, UK and published in The Color Index, Third Edition, 1971.

The yellow ink composition according to the present invention may be used in recording methods using an ink composition. Recording methods using an ink composition include, for example, an ink jet recording method, a recording method using writing utensils, such as pens, and other various printing methods. Particularly, the ink composition according to the present invention is used in the ink jet recording method.

The yellow ink composition according to the present invention comprises a colorant and a polymeric dispersant, wherein the colorant is C.I. Pigment Yellow 74 and the polymeric dispersant is a random copolymer comprising at least a first monomer which is ionic and a second monomer which is hydrophobic and is selected from the group consisting of benzyl(meth)acrylate, substituted benzyl(meth)acrylate and linear, branched and/or cyclic alkyl(meth)acrylate where the alkyl has four to ten carbons. The polymeric dispersant has a number average molecular weight of 6000 to 20000, an acid number of 80 to 200, and the second monomer is at least 65% of the weight of the dispersant.

At the outset, the yellow ink composition according to the present invention has excellent stability as its dispersion and, in turn, as a yellow ink jet ink. As described above, it has been pointed out that C.I. Pigment Yellow 74 has poor stability when other commercially available dispersants are used, especially styrene acrylic dispersants. Further, the yellow ink composition according to the present invention is excellent in various properties required of ink compositions, especially properties required of ink compositions for ink jet recording. Specifically, the present invention provides a yellow ink composition which is stable and thus can produce excellent images and hue (chroma).

In the yellow ink composition according to the present invention, the alkyl(meth)acrylate and/or benzylmethacrylate/(meth)acrylic acid polymeric dispersant substantially functions as a dispersant for C.I. Pigment Yellow 74 as the colorant. As described below, the colorant is added as a pigment dispersion to the ink composition.

It is surprising that the inventive dispersion of C.I. Pigment Yellow 74 is stable with the alkyl(meth)acrylate and/or benzylmethacrylate/(meth)acrylic acid dispersant. The literature suggests that a styrene/acrylic is sufficient to prepare a stable C.I. Pigment Yellow 74. However, the tests of available styrene/acrylic dispersions lead to unstable dispersions based on common dispersion and ink jet testing techniques, specifically, the T-Cycle and Heating Cycle test. Furthermore, in inkjet Pen Life tests, the inventive PY74 inks are very good.

Not being bound by theory it is possible that the polymeric dispersants with higher molecular weights are indicative of a larger dispersant molecule which is capable of stabilizing the Pigment Yellow 74 more than commonly used dispersants. Furthermore, the position of the benzyl or C₄ to C₈ alkyl substituent on the (meth)acrylate is such that these groups are sufficiently removed from the backbone of the dispersant leading to facile interaction with the surface of the C.I. Pigment Yellow 74. The styrene with its benzene group alpha to the polymer backbone chain may not provide sufficient stabilization for this difficult to stabilize C. I. Pigment Yellow 74.

According to the present invention, C.I. Pigment Yellow 74 may be added in such a suitable amount that a desired image density can be realized. The amount of C.I. Pigment Yellow 74 added, however, is 0.3 to 10% by weight, optionally 1 to 6% by weight, based on the ink composition. The ratio of C.I. Pigment Yellow 74 to the polymeric dispersant is about 1 to about 4.5 (weight/weight basis), or optionally about 1.5 to about 3.5.

According to another embodiment of the present invention, C.I. Pigment Yellow 74 is added, to the ink, as a pigment dispersion prepared by dispersing this pigment in an aqueous medium with the aid of the dispersants described above. The average diameter of fine particles of the pigment is optionally not more than 200 nm, and suitably, not more than 120 nm. The average diameter of fines particles is denoted by d50.

The alkyl(meth)acrylate and/or benzylmethacrylate/(meth)acrylic acid dispersant used in the present invention is a random polymer. The molecular weight (Mn) thereof is about 6,000 to 20,000, more suitably about 7,000 to 16,000. The amount of alkyl(meth)acrylate and/or benzylmethacrylate monomer in the random polymer is at least about 66 weight % based on the weight of the polymeric dispersant. Thus, according to an embodiment of the present invention, the acid value of this resin is about 80 to 200, suitably about 100 to 170.

The random polymeric dispersant of the invention is prepared by common polymerization which include, but are not limited to, free radical processes, Group Transfer Processes (GTP), radical addition fragmentation (RAFT), atom transfer reaction (ATR), and the like.

The first monomer is a hydrophilic monomer, and includes, for example, methacrylic acid, acrylic acid, maleic acid, maleic acid monoester, itaconic acid, itaconic acid monoester, crotonic acid, crotonic acid monoester, and 2-acrylamido-2-propane sulfonic acid. The hydrophilic monomers are anionic.

The second monomer is hydrophobic and can be, for example, benzyl(meth)acrylate, benzyl(meth)acrylate, butyl(meth)acrylate, hexyl(meth)acrylate, 2-ethylhexyl(meth)acrylate, octyl(meth)acrylate phenyl(meth)acrylate, phenoxyethyl(meth)acrylate, p-tolyl(meth)acrylate, butyl acrylate, hexyl acrylate, 2-ethylhexyl acrylate, octyl acrylate, phenyl acrylate, phenoxyethyl acrylate, and p-tolyl acrylate.

Minor amounts of other monomers may be included in the polymerization as long as the sum of these other monomers are less than 10 wt % of the total monomers used in the polymerization. These monomers include the more hydrophilic monomers maleic acid, maleic acid monoester, itaconic acid, itaconic acid monoester, crotonic acid, crotonic acid monoester, N,N-dimethylaminoethyl methacrylate, N,N-diethylaminoethyl methacrylate, N,N-dimethylaminoethyl acrylate, N,N-diethylaminoethyl acrylate, t-butylaminoethyl methacrylate, t-butylaminoethyl acrylate, vinyl pyridine, N-vinyl pyridine, and 2-acrylamido-2-propane sulfonic acid. Also included at less than 10 wt % can be the more hydrophobic monomers methyl methacrylate, ethyl methacrylate, propyl methacrylate, phenyl methacrylate, phenoxyethyl methacrylate, p-tolyl methacrylate, sorbyl methacrylate, methyl acrylate, ethyl acrylate, propyl acrylate, butyl acrylate, hexyl acrylate, 2-ethylhexyl acrylate, octyl acrylate, phenyl acrylate, and phenoxyethyl acrylate. The PY74 is prepared by dispersing with the dispersants described above and may be prepared by methods known in the art. It is generally desirable to make the stabilized PY74 in a concentrated form. The stabilized PY74 is first prepared by premixing the selected PY74(s) and polymeric dispersant(s) described above in an aqueous carrier medium (such as water and, optionally, a water-miscible solvent), and then dispersing or deflocculating the PY74. The dispersing step may be accomplished in a 2-roll mill, media mill, a horizontal mini mill, a ball mill, an attritor, or by passing the mixture through a plurality of nozzles within a liquid jet interaction chamber at a liquid pressure of at least 5,000 psi to produce a uniform dispersion of the PY74 particles in the aqueous carrier medium (microfluidizer). Alternatively, the concentrates may be prepared by dry milling the polymeric dispersant and the PY74 under pressure. The media for the media mill is chosen from commonly available media, including zirconia, YTZ, and nylon. These various dispersion processes are in a general sense well known in the art, as exemplified by U.S. Pat. No. 5,022,592, U.S. Pat. No. 5,026,427, U.S. Pat. No. 5,310,778, U.S. Pat. No. 5,891,231, U.S. Pat. No. 5,679,138, U.S. Pat. No. 5,976,232 and US Application Publication No. 2003/0089277. Most commonly used dispersion methods are 2-roll mill, media mill, and by passing the mixture through a plurality of nozzles within a liquid jet interaction chamber at a liquid pressure of at least 5,000 psi.

After the milling process is complete the PY74 concentrate may be “let down” into an aqueous system. “Let down” refers to the dilution of the concentrate with mixing or dispersing, the intensity of the mixing/dispersing normally being determined by trial and error using routine methodology, and often being dependent on the combination of the polymeric dispersant, water, a miscible solvent and PY74.

### Inkjet Ink

In one aspect the present invention pertains to an inkjet ink comprising the inks which have the prescribed Pigment Yellow 74 dispersion. The ink jet ink with Pigment Yellow 74 has a surface tension in the range of about 20 dyne/cm to about 70 dyne/cm at 25° C., and a viscosity of lower than about 30 cP at 25° C.

### Vehicle

The ink vehicle is the carrier (or medium) for the colorant. An “aqueous vehicle” refers to a vehicle comprised of water or a mixture of water and at least one water-soluble organic solvent (co-solvent) or humectant. Selection of a suitable mixture depends on requirements of the specific application, such as desired surface tension and viscosity, the selected colorant, and compatibility with substrate onto which the ink will be printed.

Examples of water-soluble organic solvents and humectants include: alcohols, ketones, keto-alcohols, ethers and others, such as thiodiglycol, sulfolane, 2-pyrrolidone, 1,3-dimethyl-2-imidazolidinone and caprolactam; glycols such as ethylene glycol, diethylene glycol, triethylene glycol, tetraethylene glycol, propylene glycol, dipropylene glycol, tripropylene glycol, trimethylene glycol, butylene glycol and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, diethylene glycol monoethyl ether; lower dialkyl ethers of polyhydric alcohols, such as diethylene glycol dimethyl or diethyl ether; urea and substituted ureas.

An aqueous vehicle will typically contain about 30% to about 95% water with the balance (i.e., about 70% to about 5%) being the water-soluble solvent. Ink compositions typically contain about 60% to about 95% water, based on the total weight of the aqueous vehicle.

### Additives

Other ingredients, additives, may be formulated into the inkjet ink, to the extent that such other ingredients do not interfere with the stability and jetablity of the finished ink, which may be readily determined by routine experimentation. Such other ingredients are in a general sense well known in the art.

Commonly, surfactants are added to the ink to adjust surface tension and wetting properties. Suitable surfactants include ethoxylated acetylene diols (e.g. Surfynols® series from Air Products), ethoxylated primary (e.g. Tomadol® series from Tomah Products) and secondary (e.g. Tergitol® series from Union Carbide) alcohols, sulfosuccinates (e.g. Aerosol® series from Cytec), organosilicones (e.g. Silwet® series from GE Silicons) and fluoro surfactants (e.g. Zonyl® series from DuPont). Surfactants are typically used in the amount of about 0.01 to about 5% and optionally about 0.2 to about 2%, based on the total weight of the ink.

Polymers may be added to the ink to improve durability. The polymers can be soluble in the vehicle or dispersed (e.g. “emulsion polymer” or “latex”), and can be ionic or nonionic. Useful classes of polymers include acrylics, styrene-acrylics and polyurethanes. The alkyl(meth)acrylate and/or benzylmethacrylate/(meth)acrylic acid dispersant described above may be added to the ink composition, but would act as polymer additive to the ink, not a dispersant when added in this manner.

Biocides may be used to inhibit growth of microorganisms. Buffers may be used to maintain pH. Buffers include, for example, tris(hydroxymethyl)-aminomethane (“Trizma” or “Tris”).

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″, N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

### Proportions of Ingredients

The components described above can be combined to make an ink in various proportions and combinations in order to achieve desired ink properties, as generally described above, and as generally recognized by those of ordinary skill in the art. Some experimentation may be necessary to optimize inks for a particular end use, but such optimization is generally within the skill of one of ordinary skill in the art.

The amount of vehicle in an ink is typically in the range of about 70% to about 99.8%, and more typically about 80% to about 99%. Colorant is generally present in amounts up to about 10%. Percentages are weight percent of the total weight of ink.

Other ingredients (additives), when present, generally comprise less than about 15% by weight, based on the total weight of the ink. Surfactants, when added, are generally in the range of about 0.2 to about 3% by weight based on the total weight of the ink. Polymers can be added as needed, but will generally be less than about 15% by weight based on the total weight of the ink.

### Ink Properties

Drop velocity, separation length of the droplets, drop size and stream stability are greatly affected by the surface tension and the viscosity of the ink. Ink jet inks typically have a surface tension in the range of about 20 dyne/cm to about 70 dyne/cm at 25° C. Viscosity can be as high as 30 cP at 25° C., but is typically somewhat lower. The ink has physical properties are adjusted to the ejecting conditions and printhead design. The inks should have excellent storage stability for long periods so as not clog to a significant extent in an ink jet apparatus. Further, the ink should not corrode parts of the ink jet printing device it comes in contact with, and it should be essentially odorless and non-toxic.

### Ink Sets

The term “ink set” refers to a set of inks with the yellow ink being the C. I. Pigment Yellow 74 ink. Ink sets typically comprise at three differently colored inks such as cyan, magenta and yellow (CMY), which in this case includes the C. I. Pigment Yellow 74. And still more typically at least four differently colored inks where black (K) is added to the CMY wherein at least the yellow ink is a C. I. Pigment Yellow 74 of the inks is an aqueous inkjet ink as described above.

In addition to the typical CMYK inks, the ink sets in accordance with the present invention may further comprise one or more “gamut-expanding” inks, including different colored inks such as an orange ink, a green ink, a red ink and/or a blue ink, and combinations of full strength and light strength inks such as light cyan and light magenta. Such other inks are, in a general sense, known to those of ordinary skill in the art.

### Method of Printing

The inks and ink sets of the present invention can be printed with any suitable inkjet printer including a printer equipped with “piezo” and “thermal” printheads. The substrate can be any suitable substrate including paper such as “plain” paper, and inkjet specialty and glossy paper, textiles and other common ink jet printed substrates.

### EXAMPLES

Various dispersants were tested with C. I. Pigment Yellow 74 including the inventive dispersants. Other dispersants were either prepared as described below or were commercially available from Joncryls from SC Johnson, Racine Wis.; Disperbyks from Byk Chemie, Wallingford Conn.; SMA 1440, Elf Arkema, France.

Different sources of C. I. Pigment 74 were used: Dainichiseika TRY-3 PY74 (Dainichiseika Color and Chemicals Mfg. Co., Tokyo, Japan); European Color Eljon Yellow PY74 (EC Pigments, Fall River, Mass.); Sunbrite 0272-0559 PY74 (Sun Chemical Co., Parsippany, N.J.); Clariant Hansa Yellow 5GX-03 (Clariant, Coventry, R.I.); and Ciba Chromophthal Yellow PY128 (Ciba Corporation, Newport, Del.

### Polymeric Dispersant 1: 39BzMA/30MAA

A 3L, 3-necked round bottom was loaded with 759 g tetrahydrofuran and 16.6 g dimethyl ketene 2-trimethylsiloxyethyl trimethylsilyl acetal, 0.18 mL tetrabutyl ammonium m-chlorobenzoate (1 M in acetonitrile) and 1.03 g mesitylene (HPLC standard). Feed 2—(trimethylsiloxy)ethyl methacrylate (339 g) and benzyl methacrylate (491 g) over 60 minutes. Using a syringe pump, a catalyst solution of 0.17 mL tetrabutyl ammonium m-chlorobenzoate (1 M in acetonitrile) and 5.2 g tetrahydrofuran was fed concurrently with the above addition. Temperature was kept below 45° C. After 5 hrs, the reaction was quenched with 145 g methanol. The tetrahydrofuran was distilled and replaced with diethylene glycol. The final product had solids of 45.7%, acid value of 3.08 mEq/mg KOH, and GPC analysis revealed Mn=9924, Mw=11784, and PD=1.19 (Theoretical Mn=9444).

### Polymeric Dispersant 2: 30BzMA/15MAA

A 3L, 3-necked round bottom was loaded with 504 g tetrahydrofuran and 17.3 g dimethyl ketene 2-trimethylsiloxyethyl trimethylsilyl acetal, 0.3 mL tetrabutyl ammonium m-chlorobenzoate (1 M in acetonitrile) and 1.06 g mesitylene (HPLC standard). 2-(trimethylsiloxy)ethyl methacrylate (176.8 g) and 391.5 g benzyl methacrylate was fed over 45 minutes. Using a syringe pump, a catalyst solution of 0.3 mL tetrabutyl ammonium m-chlorobenzoate (1 M in acetonitrile) and 5.8 g tetrahydrofuran was fed concurrently with the above addition. The reaction temperature rose to 66° C. After 2.5 hrs, the reaction was quenched with 126 g methanol and 0.4 g dichloroacetic acid. The tetrahydrofuran was distilled and replaced with diethylene glycol. The final product had solids of 42.1% polymer, an acid value of 2.36 mEq/mg KOH, and GPC analysis revealed Mn=7258, Mw=9001, and PD=1.24 (Theoretical Mn=6570).

### Polymeric Dispersant 3: 49BzMA/20MAA

A 3L, 3-necked round bottom was loaded with 909 g tetrahydrofuran and 19.7 g dimethyl ketene 2-trimethylsiloxyethyl trimethylsilyl acetal, 0.34 mL tetrabutyl ammonium m-chlorobenzoate (1 M in acetonitrile) and 1.95 g mesitylene (HPLC standard). 2-(trimethylsiloxy)ethyl methacrylate (268.4 g) and 732.4 g benzyl methacrylate was fed over 60 minutes. Using a syringe pump, a catalyst solution of 0.34 mL tetrabutyl ammonium m-chlorobenzoate (1 M in acetonitrile) and 5.8 g tetrahydrofuran was fed concurrently with the above addition. The reaction temperature rose to 66° C. After 3 hrs, the reaction was quenched with 120 g methanol. The tetrahydrofuran was distilled and replaced with diethylene glycol. The final product had solids of 43.6% polymer, an acid value of 2.04 mEq/mg KOH, and GPC analysis revealed Mn=10709, Mw=12790, and PD=1.19 (Theoretical Mn=10437).

### Polymeric Dispersant 4: 65BzMA/50MAA

A 3L, 3-necked round bottom was loaded with 907 g tetrahydrofuran and 11.4 g dimethyl ketene 2-trimethylsiloxyethyl trimethylsilyl acetal, 0.22 mL tetrabutyl ammonium m-chlorobenzoate (1 M in acetonitrile) and 1.07 g mesitylene (HPLC standard). 2-(trimethylsiloxy)ethyl methacrylate (388.2 g) and 562.4 g benzyl methacrylate was fed over 60 minutes. Using a syringe pump, a catalyst solution of 0.22 mL tetrabutyl ammonium m-chlorobenzoate (1 M in acetonitrile) and 5.4 g tetrahydrofuran was fed concurrently with the above addition. The reaction temperature rose to 40° C. After allowing the reaction to continue overnight, the reaction was quenched with 181 g methanol. The tetrahydrofuran was distilled and replaced with diethylene glycol. The final product had solids of 46.2% polymer, an acid value of 3.06 mEq/mg KOH, and GPC analysis revealed Mn=16797, Mw=20150, and PD=1.20 (Theoretical Mn=15740).

### Polymeric Dispersant 5: 26BzMA/20MAA

A 3L, 3-necked round bottom was loaded with 391 g tetrahydrofuran and 30.5 g dimethyl ketene 2-trimethylsiloxyethyl trimethylsilyl acetal, and 0.32 mL tetrabutyl ammonium m-chlorobenzoate (1 M in acetonitrile). 2-(trimethylsiloxy)ethyl methacrylate (415.5 g) and 601.3 g benzyl methacrylate was fed over 60 minutes. Using a syringe pump, a catalyst solution of 0.32 mL tetrabutyl ammonium m-chlorobenzoate (1 M in acetonitrile) and 4.6 g tetrahydrofuran was fed concurrently with the above addition. The reaction temperature rose to 37° C. After 5 hrs, the reaction was quenched with 177 g methanol. The tetrahydrofuran was distilled and replaced with diethylene glycol. The final product had solids of 53.8% polymer, an acid value of 3.13 mEq/mg KOH, and GPC analysis revealed Mn=6997, Mw=8654, and PD=1.24 (Theoretical Mn=6296).

### Polymeric Dispersant 6: 49BMA/20MAA

The butyl methacrylate (BMA) equivalent of Polymeric Dispersant 3 was prepared in an similar way to Dispersant 4.

### Comparison Polymer A BZMA/MAA 90/10 Random Linear, Via Group Transfer Polymerization (GTP)

A 5-liter flask was equipped with a mechanical stirrer, thermometer, N₂ inlet, drying tube outlet, and addition funnels. Tetrahydrofuran (THF), 1715.1 gm, was charged to the flask. The catalyst tetrabutyl ammonium m-chlorobenzoate, 1.2 ml of a 1.0 M solution in acetonitrile, was then added. Initiator, 1-methoxy-1-trimethylsiloxy-2-methyl propene, 51.33 gm (0.295 moles) was injected. Feed I—[tetrabutyl ammonium m-chlorobenzoate, 1.2 ml of a 1.0 M solution in acetonitrile and THF, 10.0 gm] was started and added over 180 minutes. Feed II—[trimethylsilyl methacrylate, 267.6 gm (1.69 moles) and benzyl methacrylate(BZMA), 1,305.6 gm (7.42 moles)] was started at 0.0 minutes and added over 70 minutes.

At 173 minutes, 60.5 gm of methanol was added to the above solution and distillation began. During the first stage of distillation, 503.0 gm of material was removed. The final polymer was 51.5% solids.

The polymer had a composition of BZMA/methyl methacrylate (MAA) 90/10; molecular weight of Mn=5,048 and an acid value of 1.24 (milliequivalents/gram of polymer solids) based on total solids.

### Comparison Polymer B Block Polymer BZMA//MAA 13//10

The following is an example of how to make a block polymer that has both ionic as well as steric stabilization. The composition is BZMA//MAA 13//10.

A 12-liter flask was equipped with a mechanical stirrer, thermometer, N₂ inlet, drying tube outlet, and addition funnels. Tetrahydrofuran THF, 3750 gm, and p-xylene, 7.4 gm, were charged to the flask. The catalyst tetrabutyl ammonium m-chlorobenzoate, 3.0 mL of a 1.0 M solution in acetonitrile, was then added. Initiator, 1,1-bis(trimethylsiloxy)-2-methyl propene, 291.1 gm (1.25 moles) was injected. Feed I—[tetrabutyl ammonium m-chlorobenzoate, 3.0 mL of a 1.0 M solution in acetonitrile] was started and added over 180 minutes. Feed II—[trimethylsilyl methacrylate, 1975 gm (12.5 moles)] was started at 0.0 minutes and added over 35 minutes. One hundred minutes after Feed II was completed (over 99% of the monomers had reacted) Feed III—[benzyl methacrylate, 2860 gm (16.3 moles) was started and added over 30 minutes.

At 400 minutes, 720 gm of methanol was added to the above solution and distillation began. During the first stage of distillation, 1764.0 gm of material was removed. Then more methanol 304.0 gm was added and an additional 2255.0 gm of material was distilled out. It was at 49.7% solids.

The polymer has a composition of BZMA//MAA 13//10. It has a molecular weight of Mn=3,200; acid value, 3.52.

### Comparison Polymer C: Diblock 8ETEGMA//30BMA/6MAA

A 3-liter round bottom flask was dried with a heat gun under nitrogen purge and equipped with a mechanical stirrer, thermocouple, N₂ inlet, drying tube outlet, and addition funnels. Tetrahydrofuran (THF), 605 g, was cannulated to the flask. Initiator (1,1-bis(trimethylsilyloxy)-2-methyl propene, 28.5 g (0.123 moles)) was injected followed by catalyst (tetrabutyl ammonium m-chlorobenzoate, 0.7 mL of a 1.0 M solution in acetonitrile). Catalyst solution (tetrabutyl ammonium m-chlorobenzoate, 0.5 mL of a 1.0 M solution in acetonitrile and THF, 10 g) was syringe pumped during both the monomer feeds. Monomer feed 1—(trimethylsilyl methacrylate 108.6 g (0.833 mol) and butyl methacrylate, 486.8 g (3.43 mol)) was added over 60 minutes while the reaction exotherm to 65° C. After a 1 hr hold, HPLC indicated greater than 95% monomer conversion, and then, monomer feed II—(ethyl triethylene glycol methacrylate, 224.1 g (0.910 mol)) was added over 60 minutes.

The ETEGMA conversion was greater than 98% 30 min after the feed was complete. 50.8 g of methanol were added, and then the THF and other volatile by-products were distillated by slowly heating to 120° C. while adding 2-pyrrolidone (2P). The final polymer solution was 49.3% solids with a measured number of 57.3 (mg KOH/gram of polymer solids). The molecular weight of this polymer as measured by GPC was Mn 7988, Mw 8529, and PD 1.07.

### Comparison Polymer D Diblock 4ETEGMA/4DMAEMA//30BMA/7MAA

A 3-liter round bottom was dried with a heat gun under nitrogen purge and equipped with a mechanical stirrer, thermocouple, N₂ inlet, drying tube outlet, and addition funnels. Tetrahydrofuran (THF), 620 g, was cannulated to the flask. Initiator (1,1-bis(trimethylsilyloxy)-2-methyl propene, 26.6 g (0.115 moles)) was injected followed by catalyst (tetrabutyl ammonium m-chlorobenzoate, 0.7 mL of a 1.0 M solution in acetonitrile). Catalyst solution (tetrabutyl ammonium m-chlorobenzoate, 0.5 mL of a 1.0 M solution in acetonitrile and THF, 13 g) was syringe pumped during both the monomer feeds. Monomer feed 1—(trimethylsilyl methacrylate 127.5 g (0.966 mol) and butyl methacrylate, 488.5 g (3.44 mol)) was added over 60 minutes while the reaction exotherm to 64° C. After 60 min hold, HPLC indicated greater than 96% monomer conversion, and then, monomer feed II—(ethyl triethylene glycol methacrylate, 117.4 g (0.477 mol) and 2-(dimethylamino)ethyl methacrylate, 72.5 g (0.462 mol)) was added over 15 minutes.

After 20 min, the monomer conversion was greater than 96%. Added 59 g of methanol, and then the THF and other volatile by-products were distillated by slowly heating to 120° C. while adding 2-pyrrolidone (2P). The final polymer solution was 45.6% solids with a measured number of 78.5 (mg KOH/gram of polymer solids).

### Comparison Polymer E: 30BzMA/10MAA

A 3 L, 3-necked round bottom was loaded with 766 g tetrahydrofuran and 60.3 g dimethyl ketene 2-trimethylsiloxyethyl trimethylsilyl acetal, and 0.62 mL tetrabutyl ammonium m-chlorobenzoate (1 M in acetonitrile). Feed 2—(trimethylsiloxy)ethyl methacrylate (408.6 g) and 590.8.4 g benzyl methacrylate over 60 minutes. Using a syringe pump, a catalyst solution of 0.62 mL tetrabutyl ammonium m-chlorobenzoate (1 M in acetonitrile) and 5.8 g tetrahydrofuran was feed concurrently with the above addition. The reaction temperature rose to 33° C. After 4.5 hrs, the reaction was quenched with 182 g methanol. The tetrahydrofuran was distilled and replaced with diethylene glycol. The final product had solids of 53.2% polymer, an acid value of 3.21 mEq/mg KOH, and GPC analysis revealed Mn=3453, Mw=3928, and PD=1.14 (Theoretical Mn=3148).

### Dispersion Preparation

Pigment Yellow 74 was milled with various dispersants. First 25 wt % pigment and ˜10 wt % (depending on the pigment/dispersant ratio) dispersant were mixed into water and a 1,2-hexanediol or diethyleneglycol cosolvent. An HSD was used to obtain the initial premix. Then this mixture was diluted to 23 wt % pigment and added to an Eiger Mill with 0.5 mm YTZ media. The samples were milled for 4 hours or longer to obtain the desired dispersion.

The finished dispersions were tested for particle size (Microtracs & Accusizer), pH, conductivity, viscosity, and overall % solids. The dispersions were then filtered through a 0.3 micron (“chipwich”) filter, and the same measurements were run again.

A small sample (˜38 g) of each dispersion was then oven aged for two weeks at 70° C. Over that two-week period, the sample was removed from the oven after 1 day, 1 week, and then upon completion at 2 weeks. During each removal period from the oven, the dispersion was cooled to room temperature and the above tests (minus % solids) were remeasured before the sample was put back into the oven (for the 1-day and 1-week removal only; the 2-week sample, at the end of its cycle, was stored and tested).

### Preparation and Testing of Inks

Inks were prepared with various dispersions above according to the same general Ink Formulation, given below. Ingredients, given as weight percent of the total weight of ink, were mixed together and filtered. Water was deionized. Byk® 348 is a surfactant from Byk Chemie).

### T-Cycle Test

The samples are placed in a Thermotron Environmental test chamber (Thermotron Industries, Holland, Mich.) at −40 C for 4 hours, the temperature is then raised to 70 C over a 30 minute period and then maintained at that temperature for another 4 hours, and then the temperature is lowered to −40C again over a 30 minute period. This cycle is repeated for a total of four cycles. The physical properties and particle size of the inks or dispersions are measured before and after the test.

### Oven Test

The samples are placed in an oven maintained at 60° C. for 2 weeks. The physical properties and particle size of the inks or dispersions are measured before and after the test.

### Pen Life Test

The inks are filled into an empty Hewlett Packard 88 inkjet cartridge and then placed in an HP K550 printer for testing. A test pattern is printed repeatedly until the cartridge runs out of ink, typically 160 pages. The test pattern contains a 0.5 point width line and an area printed with a 1/64th halftone. The mean width deviation of the 0.5 point line and the number of ink dots in the 1/64th tone area are measured using an ImageXpert system on the initial page and very tenth subsequent page. The average of the line mean width deviation for all the pages measured is then calculated. This is a measure of misdirected drops being fired form the printhead. The more misdirected drops there are, the more ragged the line and the higher is the value of the mean width deviation. A value of 30 microns or less is good, and a value of 20 microns or less is excellent. The standard deviation of the number of dots in the halftone pattern is also calculated for all the pages sampled. This is a measure of jetting consistency. If the standard deviation is high then nozzles are failing to fire. A value of 10 or less is good, 5 or less is excellent.

### Dispersion Testing

The dispersion of Pigment Yellow 74 were prepared and tested. The particle size and sedimentation increase after heating the dispersions for 1 week at 70° C. are summarized in Table 1 below.

TABLE 1
Tests of Pigment Yellow 74 Dispersions

| | | | | | D 50% change | Sediment |
|---|---|---|---|---|---|---|
| | | | | | after one | after one |
| Disp. | | | Acid | Initial | week | week |
| No. | Dispersant | Mn | No. | d50, nm | @70° C. | @70° C. |
| A | 13BzMA//10MAA | 3015 | 191 | 79 | 71% | 13% |
| B | Joncryl 671 | | | | | |
| C | 13 BzMA/10MAA | 3453 | 180 | 63 | 43% | 25% |
| 5 | 26 BzMA/20MAA | 6997 | 176 | 57 | 41% | 13% |
| 2 | 30BzMA/15MAA | 7258 | 132 | 65 | 20% | 6% |
| 1 | 39 BzMA/30MAA | 9924 | 173 | 59 | 12% | trace |
| 3 | 49BzMA/20MAA | 10709 | 114 | 74 | 6% | none |
| 4 | 65BzMA/50MAA | 16797 | 172 | 71 | 10% | trace |

The inventive dispersions have significantly better properties after this heat aging test.

Ink Set 1:

Inventive and comparison inks were tested in the oven aging test. The formulation of the ink is listed in Table 2.

TABLE 2
Ink Set 1 Formulation

| Ingredient | Weight % |
|---|---|
| Dispersion | 35.9 |
| 1,2-hexanediol | 5.3 |
| Glycerol | 14.10 |
| Byk 348 | 0.5 |
| Water | 44 |

TABLE 3
Comparison Ink A (from Comparison Dispersion B)

| Property | As made | After Oven Test |
|---|---|---|
| pH | 9.0 | 8.87 |
| Conductivity | 1.56 | 1.72 |
| Surface tension | 26.44 | 26.81 |
| Viscosity | 3.44 | 3.44 |
| Median particle size | 94.2 | 125.2 |
| D95 | 175.1 | 272.6 |
| % particles <204 nm | 97.64 | 86.85 |

TABLE 4
Comparison Ink B (from Dispersion = Joncryl 671)

| Property | As made | After Oven Test |
|---|---|---|
| pH | 8.9 | 8.65 |
| Conductivity | 1.840 | 1.92 |
| Surface tension | 27.14 | 28.34 |
| Viscosity | 3.86 | 4.45 |
| Median particle size | 76.6 | 99.0 |
| D95 | 159.6 | 268.1 |
| % particles <204 nm | 100.0 | 89.23 |

TABLE 5
Ink 1 Polymeric Dispersion 2

| Property | As made | After Oven Test |
|---|---|---|
| pH | 9.0 | 8.97 |
| Conductivity | 1.07 | 1.22 |
| Surface tension | 25.44 | 26.52 |
| Viscosity | 4.05 | 3.72 |
| Median particle size | 79.1 | 104.5 |
| D95 | 179.1 | 254.7 |
| % particles <204 nm | 97.8 | 88.13 |

TABLE 6
Ink 2 Polymeric Dispersion 1

| Property | As made | After Oven Test |
|---|---|---|
| pH | 8.98 | 8.87 |
| Conductivity | 1.21 | 1.36 |
| Surface tension | 25.03 | 26.2 |
| Viscosity | 4.09 | 3.97 |
| Median particle size | 68.00 | 130.4 |
| D95 | 157.00 | 269.6 |
| % particles <204 nm | 100.0 | 86.18 |

TABLE 7
Ink 3 Polymeric Dispersion 4

| Property | As made | After Oven Test |
|---|---|---|
| pH | 8.94 | 8.61 |
| Conductivity | 1.25 | 1.55 |
| Surface tension | 24.94 | 26.15 |
| Viscosity | 3.44 | 3.44 |
| Median particle size | 82.2 | 108.0 |
| D95 | 148.6 | 232.0 |
| % particles <204 nm | 98.85 | 91.53 |

TABLE 8
Ink 4 Polymeric Dispersion 3

| Property | As made | After Oven Test |
|---|---|---|
| pH | 8.75 | 8.62 |
| Conductivity | 1.173 | 1.29 |
| Surface tension | 26.26 | 26.41 |
| Viscosity | 3.16 | 3.06 |
| Median particle size | 67.1 | 89.6 |
| D95 | 118.9 | 170.8 |
| % particles <204 nm | 100.0 | 100.0 |

Each of the inventive inks of Ink Set 1 tested in the oven test were adequately stable for ink jet ink use.

Ink Set 2

Dispersions were prepared using the Inventive Dispersant 3 and tested by the oven test.

TABLE 9
Dispersions for Ink Set 2

| | | | | | | Final Particle Size; | | | | | |
|---|---|---|---|---|---|---|---|---|---|---|---|
| | | | Initial Particle Size | | | after oven test | | | | | |
| | | | D50 | D95 | | D50 | D95 | | D50 % | D95 % | Accusizer |
| Pigment | Dispersant | P/D | (nm) | (nm) | Accu. | (nm) | (nm) | Accu. | Increase | Increase | Increase |
| Dainichiseika | Dispersant | 2.5 | 88 | 191 | 17 | 94 | 214 | 95 | 6% | 12% | 78 |
| TRY-3 PY74 | 3 | | | | | | | | | | |
| European | Dispersant | 2.5 | 73 | 143 | 5 | 68 | 142 | 2 | −7% | −1% | −3 |
| Color Eljon | 3 | | | | | | | | | | |
| Yellow PY74 | | | | | | | | | | | |
| Sunbrite 0272- | Dispersant | 2.5 | 82 | 209 | 17 | 92 | 203 | 14 | 12% | −3% | −4 |
| 0559 PY74 | 3 | | | | | | | | | | |
| Dainichiseika | Comparison | 2.5 | 70 | 154 | 7 | 125 | 322 | 818 | 80% | 109% | 812 |
| TRY-3 PY74 | Disp 1 | | | | | | | | | | |
| Clariant 5GX- | Comparison | 2.5 | 66 | 164 | 2 | 89 | 201 | 115 | 35% | 22% | 112 |
| 03 PY74 | Disp 1 | | | | | | | | | | |
| Sunbrite 0272- | Comparison | 2.0 | 85 | 215 | 13 | 98 | 179 | ND | 16% | −17% | |
| 0559 PY74 | Disp 2 | | | | | | | | | | |
| Sunbrite 0272- | Comparison | 2.5 | 88 | 192 | 7 | 111 | 189 | 17 | 26% | −2% | 10 |
| 0559 PY74 | Disp 3 | | | | | | | | | | |
| European | Comparison | 2.5 | 82 | 200 | 10 | 119 | 236 | 754 | 45% | 18% | 744 |
| Color Eljon | Disp 3 | | | | | | | | | | |
| Yellow PY74 | | | | | | | | | | | |
| Sunbrite 0272- | Comparison | 2.5 | 83 | 169 | 20 | 96 | 226 | 216 | 16% | 34% | 197 |
| 0559 PY74 | Disp 4 | | | | | | | | | | |
| Sunbrite 0272- | Comparison | 2.0 | 96 | 240 | 25 | 119 | 237 | 33 | 23% | −1% | 9 |
| 0559 PY74 | Disp 3 | | | | | | | | | | |

The PY74 dispersions made from the inventive dispersants are significantly more stable than the dispersions prepared from comparative dispersants.

These dispersions were converted into inks using the ink formulation is shown in Table 10. The inks were tested for stability and pen life. life.

TABLE 10
Ink Vehicle Ink Set 2

| Component | Ink Vehicle, wt % |
|---|---|
| 2-Pyrrolidinone | 5.00 |
| LEG-1 | 3.00 |
| 1,2-hexanediol | 4.00 |
| Glycerol | 5.00 |
| Ethylene glycol | 5.00 |
| Surfynol 465 | 0.70 |
| Total | 22.70 |
| Surface tension | ~32 |
| (dynes/cm) | |
| Viscosity | ~2.7 |

TABLE 11
Tests of Dispersions, Ink Set 2

| | | | | | | After T- | After | | After T- | After | | After T- | After |
|---|---|---|---|---|---|---|---|---|---|---|---|---|---|
| | | | | % | | Cycle | Oven | | Cycle | Oven | | Cycle | Oven |
| Ink | Pigment | Dispersant | P/D | Pigment | Initial | test | Test | Initial | test | Test | Initial | test | Test |
| Ink 5 | Dainichiseika | Polymeric | 2.5 | 3% | 83 | 112 | | 168 | 311 | | 16 | 61 | |
| | TRY-3 PY74 | Dispersant 3 | | | | | | | | | | | |
| ink 6 | European | Polymeric | 2.5 | 3% | 70 | 83 | | 144 | 138 | | 0 | 0 | |
| | Color Eljon | Dispersant 3 | | | | | | | | | | | |
| | Yellow PY74 | | | | | | | | | | | | |
| Ink 7 | Sunbrite | Polymeric | 2.5 | 3% | 91 | 88 | | 202 | 231 | | 2 | 7 | |
| | 0272-0559 | Dispersant 3 | | | | | | | | | | | |
| | PY74 | | | | | | | | | | | | |
| Ink 8 | Sunbrite | Polymeric | 2 | 3% | 86 | 93 | | 175 | 201 | | 1 | 3 | |
| | 0272-0559 | Dispersant 6 | | | | | | | | | | | |
| | PY74 | | | | | | | | | | | | |
| Comp | Dainichiseika | Comp Polymer | 2.5 | 4% | 67 | | 136 | 151 | | 378 | 2 | | 804 |
| Ink C | TRY-3 PY74 | Disp A | | | | | | | | | | | |
| Comp | Clariant 5GX- | Comp Polymer | 2.5 | 4% | 68 | | 87 | 159 | | 229 | 1 | | 56 |
| Ink D | 03 PY74 | Disp A | | | | | | | | | | | |
| Comp | Margarita | Comp Polymer | 1.5 | 3.00% | 85 | 75 | | 163 | 156 | | 6 | 7 | |
| Ink E | PY128 | Disp B | | | | | | | | | | | |
| Comp | Margarita | Comp Polymer | 1.5 | 4.50% | 81 | 80 | | 167 | 161 | | 10 | 12 | |
| Ink F | PY128 | Disp B | | | | | | | | | | | |
| Comp | Sunbrite | Comp Polymer | 2.5 | 3% | 83 | 123 | | 168 | 213 | | 1 | 22 | |
| Ink G | 0272-0559 | Disp C | | | | | | | | | | | |
| | PY74 | | | | | | | | | | | | |
| Comp | European | Comp Polymer | 2.5 | 3% | 109 | 110 | | 189 | 251 | | 1 | 70 | |
| Ink H | Color Eljon | Disp C | | | | | | | | | | | |
| | Yellow PY74 | | | | | | | | | | | | |

TABLE 12
Pen Life Data Ink Set 2

| | | | | | Average Mean | Dot |
|---|---|---|---|---|---|---|
| | | | | % | Deviation | Number |
| Ink | Pigment | Dispersant | P/D | Pigment | (microns) | deviation |
| Ink 5 | Dainichiseika | Polymeric | 2.5 | 3% | 23 | 4 |
| | TRY-3 PY74 | Dispersant 3 | | | | |
| ink 6 | European Color | Polymeric | 2.5 | 3% | 35 | 11 |
| | Eljon Yellow | Dispersant 3 | | | | |
| | PY74 | | | | | |
| Ink 7 | Sunbrite 0272- | Polymeric | 2.5 | 3% | 30 | 5 |
| | 0559 PY74 | Dispersant 3 | | | | |
| Ink 8 | Sunbrite 0272- | Polymeric | 2 | 3% | 17 | 4 |
| | 0559 PY74 | Dispersant 6 | | | | |
| Comp Ink | Dainichiseika | Comp Polymer | 2.5 | 4% | 120 | 32 |
| C | TRY-3 PY74 | Disp A | | | | |
| Comp Ink | Clariant 5GX- | Comp Polymer | 2.5 | 4% | 139 | 30 |
| D | 03 PY74 | Disp A | | | | |
| Comp Ink | Margarita | Comp Polymer | 1.5 | 3.00% | 23 | 3 |
| E | PY128 | Disp B | | | | |
| Comp Ink | Margarita | Comp Polymer | 1.5 | 4.50% | 28 | 9 |
| F | PY128 | Disp B | | | | |
| Comp Ink | Sunbrite 0272- | Comp Polymer | 2.5 | 3% | 20 | 5 |
| G | 0559 PY74 | Disp C | | | | |
| Comp Ink | European Color | Comp Polymer | 2.5 | 3% | 125 | 42 |
| H | Eljon Yellow | Disp C | | | | |
| | PY74 | | | | | |

The inventive inks were judged to be better in overall properties leading to stable inkjet inks.

These inks were tested for print quality.

TABLE 13
Optical Density and Chroma for Inventive and Comparison Inks

| | | | HP | HP | | |
|---|---|---|---|---|---|---|
| | | | Bright | Multi- | Xerox | Aver- |
| Pigment | Dispersant | P/D | White | purpose | 4200 | age |
| | | | Optical Density | | | |
| PY128 | Comp | 1.5 | 0.87 | 0.88 | 0.75 | 0.83 |
| | Dispersant B | | | | | |
| Sunbrite 0272- | Comp | 2.0 | 1.09 | 1.08 | 0.91 | 1.03 |
| 0559 PY74 | Dispersant B | | | | | |
| Clariant PY155 | Comp | 2.0 | 1.06 | 1.01 | 0.88 | 0.97 |
| | Dispersant C | | | | | |
| Sunbrite 0272- | Comp | 2.0 | 1.13 | 1.06 | 0.91 | 1.04 |
| 0559 PY74 | Dispersant C | | | | | |
| Sunbrite 0272- | Inv | 2.0 | 1.15 | 1.02 | 0.97 | 1.06 |
| 0559 PY74 | Dispersant 3 | | | | | |
| | | | Chroma | | | |
| Margarita | Comp | 1.5 | 59 | 61 | 55 | 58 |
| PY128 | Dispersant B | | | | | |
| Sunbrite 0272- | Comp | 2.0 | 84 | 85 | 74 | 81 |
| 0559 PY74 | Dispersant B | | | | | |
| Clariant PY155 | Comp | 2.0 | 76 | 76 | 68 | 73 |
| | Dispersant C | | | | | |
| Sunbrite 0272- | Comp | 2.0 | 85 | 85 | 75 | 82 |
| 0559 PY74 | Dispersant C | | | | | |
| Sunbrite 0272- | Inv | 2.0 | 88 | 89 | 77 | 85 |
| 0559 PY74 | Dispersant 3 | | | | | |

Print data showing that the OD and chroma for PY74 are higher than for the more stable PY128 and PY155 pigments. Data also shows that the inventive dispersants give OD and chroma that is comparable, or even slightly better than, the OD and chroma from lower MW dispersants.

All inks were made at 4.5% pigment in the DuPont vehicle shown in Table 10 and printed on an HP K550 printer.

### Comparative C. I. Pigment Y 74 Dispersions

Comparative Dispersions were prepared by methods described which were based on C. I. Pigment Y 74 (Hansa Brilliant 5GX-03) and commonly available commercial polymeric dispersants which had a variety of compositions, especially the Joncryl dispersants which are styrene acrylics. Each of these dispersions of the Pigment y-74 failed as shown in the “Dispersion Result column”.

TABLE 14
Tests of C I Pigment Yellow 74 with other Dispersants

| | | | Co- | Neut. | Dispersion |
|---|---|---|---|---|---|
| Dispersant | Manufacturer | Type | solvent | agent | result |
| Disperbyk 190 | Byk-Chemie | unknown | — | KOH | U, P |
| Disperbyk 191 | Byk-Chemie | acryl | — | KOH | G |
| Disperbyk 192 | Byk-Chemie | unknown | — | — | G |
| Cogrind of | Byk-Chemie | 13//10 | 1,2- | KOH | U, P |
| Comparison | | BzMA//MAA | HD/PG | | |
| Dispersant 2 and | | unknown | | | |
| Disperbyk 193 | | | | | |
| Joncryl HPD 696 | S C Johnson | Sty acryl | 1,2- | DMEA | G |
| | | | HD | | |
| Joncryl ECO 675 | S C Johnson | Sty acryl | 1,2- | DMEA | U, P |
| | | | HD | | |
| Joncryl HPD 671 | S C Johnson | Sty acryl | 1,2- | DMEA | U, P |
| | | | HD | | |
| Joncryl 586 | S C Johnson | Sty acryl | 1,2- | KOH | G |
| | | | HD | | |
| SMA 1440 | Elf Atochem | Sty/mal | dry | KOH/ | U, P/G |
| | | anhy | | DMEA | |

Table notes.
Unknown means unknown structure; Acryl means acrylate dispersant; Sty acryl means styrene acrylic dispersant; Styrene/maleic anhydride dispersant; DMEA means dimethylethanolamine neutralizing agent; Dispersion Results: U means unstable dispersion particle; P means dispersion phase separation; G means dispersion gelled.

1. A yellow pigment dispersion composition comprising an aqueous vehicle and Pigment Yellow 74 stabilized by a dispersant polymer absorbed onto the surface of the Pigment Yellow 74, said dispersant polymer is a random polymer comprising at least
a. a first monomer which is an ionic monomer;
b. a second monomer which is a hydrophobic monomer and wherein the hydrophobic monomer is selected from the group consisting of benzyl(meth)acrylate, substituted benzyl(meth)acrylate and linear, branched and cyclic alkyl(meth)acrylate where the alkyl has four to ten carbons;
c. the hydrophobic monomer is at least 65 weight % of the polymeric dispersant,
d. the random polymer has a number average molecular weight (Mn) from 6000 to 20,000; and
e. the random polymer has an acid number of from 80 to 200.

2. The dispersant polymer of claim 1, wherein the Mn of the dispersant polymer is 7,000 to 16,000.

3. The dispersant polymer of claim 1, wherein the acid number is from 100 to 170.

4. The dispersant polymer of claim 1, wherein the hydrophobic monomer is selected from the group consisting of benzyl methacrylate, butyl methacrylate and mixtures thereof.

5. The yellow pigment dispersion composition of claim 1, wherein the weight of Pigment Yellow 74 in the ink is 0.3 to 10% by weight based on the ink composition.

6. The yellow pigment dispersion composition of claim 1, wherein the weight of Pigment Yellow 74 in the ink is 1 to 6% by weight based on the ink composition.

7. The yellow pigment dispersion composition of claim 1, wherein the weight ratio of Pigment Yellow 74 to the polymeric dispersant is 1 to 4.5.

8. The yellow pigment dispersion composition of claim 1, wherein the weight ratio of Pigment Yellow 74 to the polymeric dispersant is 1.5 to 3.5.

9. An aqueous pigmented ink jet ink comprising the yellow pigment dispersion composition of claim 1, wherein the surface tension of the ink is 20 dyne/cm to 70 dyne/cm at 25° C., and the viscosity is lower than 30 cP at 25° C.

10. An ink set comprising at least the yellow pigment dispersion composition of claim 1, at least one magenta ink and at least one cyan ink.

11. An ink set comprising at least the yellow pigment dispersion composition of claim 1, at least one magenta ink, at least one cyan ink and at least one black ink.

12. A method for ink jet printing onto a substrate, comprising the steps of:
(a) providing an ink jet printer that is responsive to digital data signals;
(b) loading the printer with a substrate to be printed;
(c) loading the printer with and ink as set forth in claim 9; and
(d) printing onto the substrate using the ink in response to the digital data signals.

13. A method for ink jet printing onto a substrate, comprising the steps of:
(a) providing an ink jet printer that is responsive to digital data signals;
(b) loading the printer with a substrate to be printed;
(c) loading the printer with an ink jet ink set as set forth in claim 10; and
(d) printing onto the substrate using the inkjet ink set in response to the digital data signals.

14. A method for ink jet printing onto a substrate, comprising the steps of:
(a) providing an ink jet printer that is responsive to digital data signals;
(b) loading the printer with a substrate to be printed;
(c) loading the printer with an ink jet ink set as set forth in claim 11; and
(d) printing onto the substrate using the inkjet ink set in response to the digital data signals.
